(19) United States
(12) Patent Application Publication
(10) Pub. No.: US 2007/0001664 A1
(43) Pub. Date: Jan. 4, 2007

(54) Movement sensor and method for producing a movement sensor

(76) Inventors: Ronald Steinbrink, Erfurt (DE); Hartmut Rohde, Leutenbach (DE); Joerg Ruppert, Creuzburg (DE); Heiko Rausch, Gerstungen (DE); Frieder Sundermeier, Kornwestheim (DE)

Correspondence Address: Striker Striker & Stenby, 103 East Neck Road, Huntington, NY, 11743, US

(21) Appl. No.: 10/573,628

(22) PCT Filed: Jan. 7, 2005
(86) PCT No.: PCT/EP05/50059

§ 371 Date: Mar. 28, 2006

(30) Foreign Application Priority Data
Mar. 6, 2004 (DE) 10 2004 011 100.6

(51) Int. Cl. G01P 3/48

(52) U.S. Cl. 324/174; 324/207.25; 29/592.1

(57) ABSTRACT

A motion sensor, in particular an rpm sensor for the wheel rotation of a motor vehicle, and a method for producing a motion sensor are proposed, the motion sensor having an integrated circuit (32), connectable via an electrical cable (24), with a measured value transducer and an electronic circuit arrangement for processing the measurement signals. The sensor has a basic component (10), produced by casting or injection molding of thermoplastic, preferably polyamide, by the MID technique, into which basic component a permanent magnet (16) is integrated. A housingless integrated circuit (32) is mounted on the MID component by the flip-chip technique. The arrangement comprising the basic component (10) and the integrated circuit (32) and the permanent magnet (16) as well as the connection end of the cable (24) is sheathed, in a further method step, with an external encapsulation (42) and joined together to form a strong component unit that is well protected against environmental factors.

### PRIOR ART

The invention relates to a motion sensor, in particular an rpm sensor for the wheel rotation of a motor vehicle, and to a method for producing a motion sensor, of the kind known fundamentally from German Patent Disclosure DE 197 22 507 A. The sensor described there has a prefabricated housing part, in which an integrated circuit, including a magnetoresistive element and a permanent magnet, is placed and is spray-coated with plastic after being connected to the stranded conductors of a twin-core cable. In this way, an arrangement that is resistant to environmental factors is obtained, but its production requires a relatively high number of work steps, and because of the use of a prefabricated housing, it requires a comparatively large amount of installation space.

The object of the invention is to disclose a motion sensor and a method for producing such sensor which on the one hand entails less production effort and expense and on the other occupies less installation space. This is attained by the definitive characteristics of claims 1 and 15.

It has proved advantageous to embody the basic component as a surface-metallized injection-molded part, out of whose metallization at least one conductor track is machined by laser ablation or by currentless metallization of one of two plastic components used to produce the injection-molded part. Another advantageous feature of the basic component contemplates providing it with hot-impressed conductor tracks, preferably in the form of a metallization comprising copper with additives of platinum, aluminum, gold, silver, and/or nickel on a plastic film that is joined in the hot-stamping to the plastic of the basic component.

A permanent magnet, which is part of the measured value transducer device is preferably integrally cast with the basic component, which results in an exact, secure positioning of the permanent magnet. On the other hand, however, this permanent magnet may also be inserted, preferably glued, afterward into a preshaped recess in the basic component, or retained superficially on the face end of the basic component, expediently with the insertion of a ferromagnetic homogenizing disk between the permanent magnet and the integrated circuit. If a motion is scanned from the side, the permanent magnet may also be joined, oriented laterally, to the basic component. The permanent magnet can also be magnetized afterward, after its insertion into the basic component or after the completion of the sensor.

The integrated circuit is preferably embodied as a so-called naked chip by the flip-chip technique and joined to the face end of the basic component; contact hills of the integrated circuit are contacted with terminal points of the conductor tracks, and an underfiller of heat-hardenable plastic is placed between the integrated circuit and the basic component, to assure a secure, permanent bond of the integrated circuit to the basic component.

The basic component is made from thermoplastics, in particular polyamide or LCP (Liquid Crystal Polymer) plastics, as is an external encapsulation, which surrounds the entire arrangement, except for the region of the integrated circuit and the portion of the basic component that receives the permanent magnet. That part of the sensor is expediently sheathed by a prefabricated, cup-shaped plastic covering, which at least with its opening edge reaches into the external encapsulation of the sensor and is retained therein. The use of such a cup-shaped plastic covering with a thin wall thickness has the advantage that with a compact design and a small air gap toward the permanent magnet, the integrated circuit is well protected against environmental factors and during assembly, and no pressure or strain on the integrated circuit occur.

The electrical connection cable of the motion sensor is expediently contacted and retained by a crimped device, which is integrated with the basic component in the injection molding thereof. As a result, in conjunction with the enclosing external encapsulation of the sensor, which covers the ends of the connection cable, a secure, permanent and tight connection of the connection cable with the sensor is assured. Instead of a crimped device, however, a soldered connection or some other cold-contacting technique, such as a plug, may be used for connecting the connection cable to the conductor tracks of the basic component.

Further details and advantageous features of the invention will become apparent from the dependent claims and the description of the exemplary embodiments shown in the drawings.

Shown are:

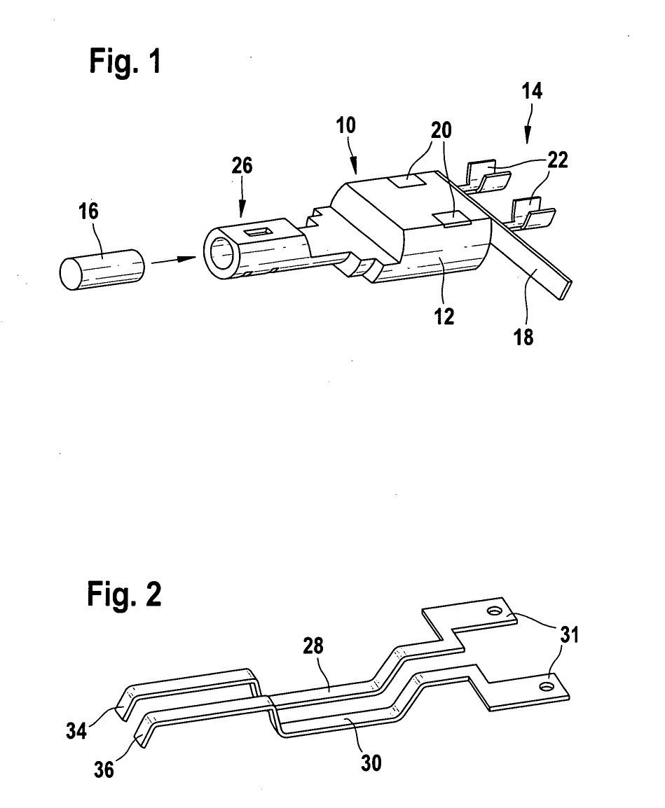

FIG. 1, a perspective view of a first embodiment of the plastic basic body of a motion sensor of the invention;

FIG. 2, the design of two conductor tracks to be applied to the plastic basic body of FIG. 1;

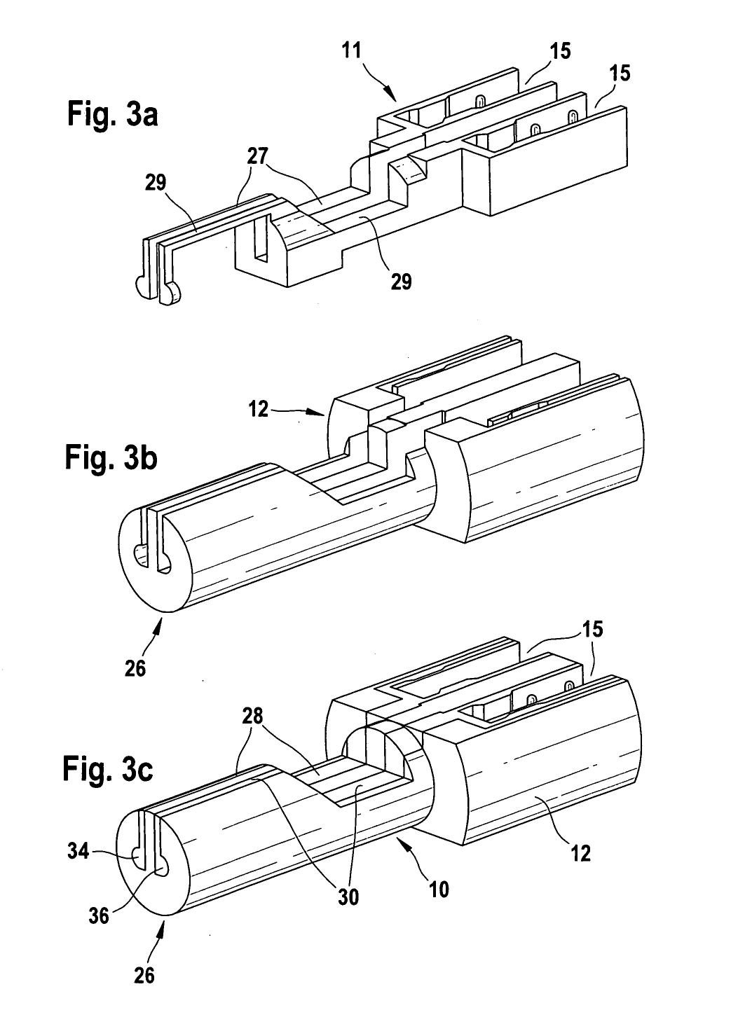

FIG. 3a, a perspective view of a first metallizable injection-molded component, in the case where the plastic basic body of the sensor basic component is produced from two different plastic components;

FIG. 3b, a perspective view of second injection-molded component of the plastic basic body of the sensor basic component;

FIG. 3c, a perspective view of the plastic basic body of the sensor basic component after the currentless application of metallizing to the first plastic component;

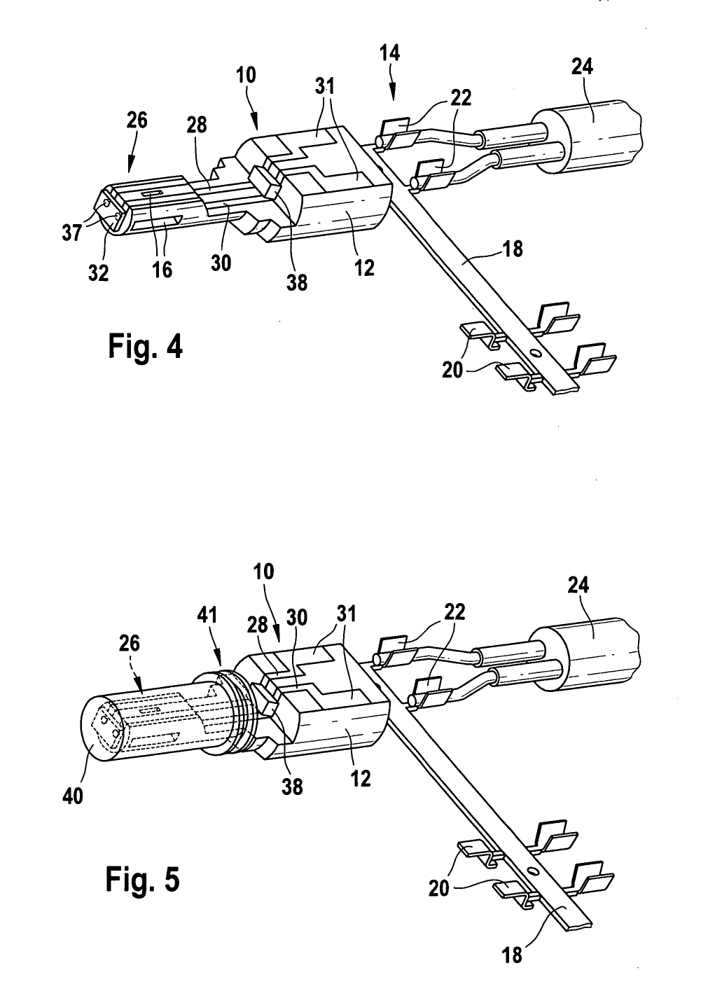

FIG. 4, a view of a completely assembled basic component of the motion sensor with an integrated circuit, a permanent magnet injected into the plastic basic body, a capacitor that bridges the conductor tracks, and a connection cable;

FIG. 5, a view of a basic component with a cup-shaped covering above the integrated circuit and with the front part, receiving the permanent magnet, of the basic component;

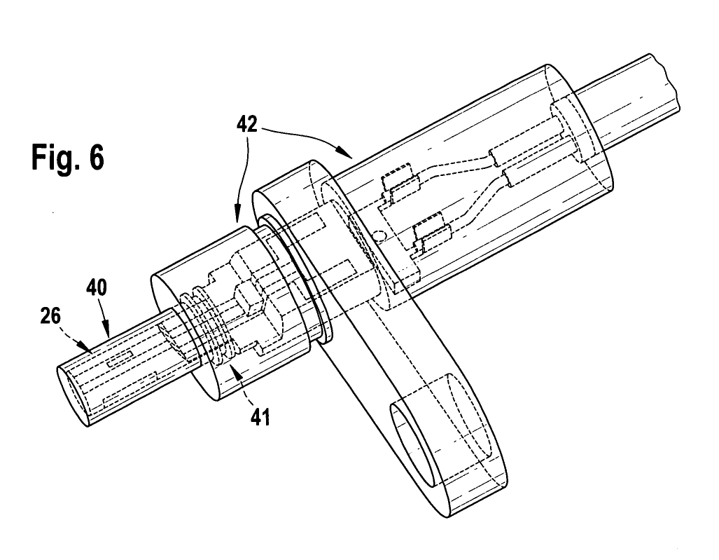

FIG. 6, a view of a finished motion sensor, showing the contours of the external encapsulation before the crimping strip is cut off and separated; and

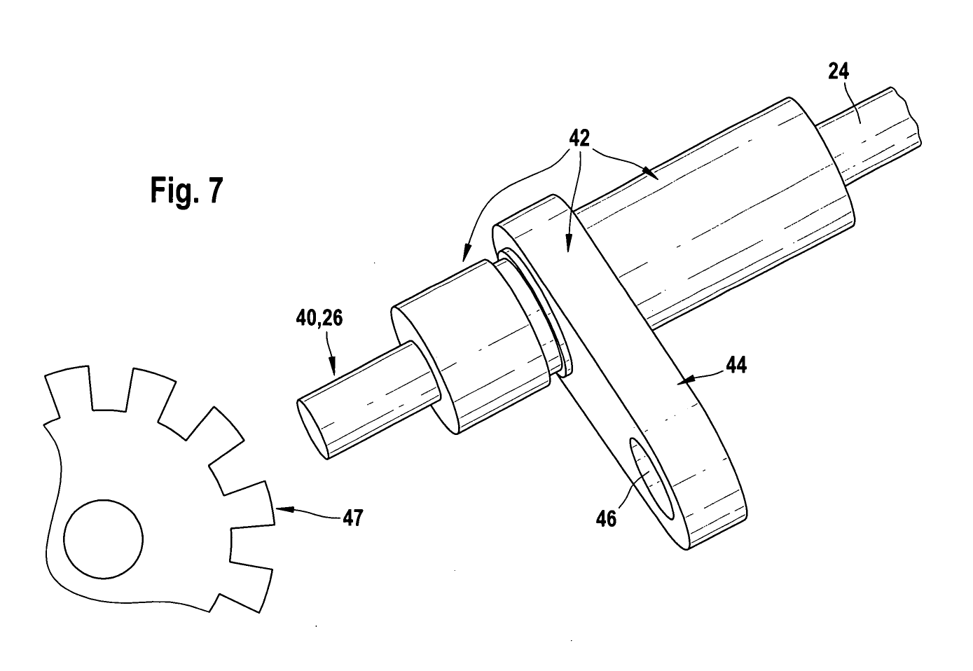

FIG. 7, a perspective view of a motion sensor encapsulated in its final form, with a transducer wheel.

In FIG. 1, 10 indicates a basic component for an rpm sensor for ascertaining the wheel rotation of a motor vehicle. The basic component in this embodiment has a plastic basic body 12, produced by injection molding from polyamide, in which a crimped device 14 is injected into the right-hand end and a permanent magnet 16 is injected into the diametrically opposite left-hand end. The crimped device 14 is part of a crimping strip 18 and is passed with its contact ends 20 through the encapsulation composition as far as the surface of the plastic basic body 12, while its crimped ends 22, for clamping to the stripped ends of the stranded conductors of a connection cable 24, protrude at the face end out of the plastic body 12. The crimping strip 18 serves solely to hold the crimped device 14 together during the encapsulation; the parts of the crimping strip 18 between the crimped ends 22 are removed before the concluding encapsulation.

In the version shown in FIG. 1, the permanent magnet 16 and the crimped device 14 are introduced as inlaid parts into the injection mold before the plastic basic body 12 is injection molded and are thus, after the completion of the plastic basic body 12, protected in it and kept correctly positioned in it. The diameter and length of the permanent magnet 16 essentially determine the shape of the sensing end 26 of the basic component 10; particularly for this part of the sensor, the goal is to minimize the dimensions, to keep the insulation space required small. The permanent magnet 16 could also be inserted afterward into a recess in the plastic basic body 12, or could be injected into the sensor in the production of the concluding external encapsulation 42 of the sensor, or held on it and secured in some other way.

FIG. 2 shows the design and the course of two conductor tracks 28 and 30 on plastic film essentially coated with copper; they are hot-impressed in the form shown onto the plastic basic body 12. The plastic film of the conductor tracks 28 and 30 bonds permanently to the plastic basic body 12, and in the region of the contact ends 20 of the crimped device 14, the copper coating of the conductor tracks 28 and 30 is joined directly to the contact ends 20 of the crimped device 14 by stamping, adhesive bonding, or soldering.

The opposed ends of the conductor tracks 28 and 30 form angled terminal points 34 and 36 for the later connection of an integrated circuit 32.

In the following figures, identical elements are identified by the same reference numerals as in FIGS. 1 and 2.

In FIG. 3, a different design of the basic component 10 is shown. It is embodied here without a crimped device, as a two-component injection-molded part with conductor tracks 28, 30 metallized onto it and with metallized recesses 15 for receiving the ends, to be soldered on, of the connection cable, not shown.

First, in FIG. 3a, an inner injection-molded part 11 is produced from a first plastic component, which can be metallized in currentless fashion, with ribs 27 and 29 corresponding to the conductor tracks 28 and 30 to be applied later by means of the metallization, and with metallizable recesses 15 for receiving the ends of the connection cable 24. The metal coating, deposited in currentless fashion, can optionally be reinforced by electroplating as well.

In a second injection-molding step, as shown in FIG. 3b, the plastic basic body 12, with the second, non-metallizable plastic component, is produced in its final form with the inclusion of the permanent magnet 16. The permanent magnet, not visible, is integrally cast into the sensing end 26 of the injection-molded part.

FIG. 3c shows the finished basic component 10 after the metallization of the plastic basic body 12, with the conductor tracks 28 and 30 and their terminal points 34 and 36 for the integrated circuit 32 and with the metallized recesses 15 for soldering in the cable ends.

In FIG. 4, a basic component 10 is shown with conductor tracks 28 and 30 applied by hot-impressing, whose contact lugs 31 are joined to the contact ends 20 of the crimped device 14. The crimped ends 22 are joined to the ends of two stranded conductors of the connection cable 24 or to the contact ends of a plug.

Instead of hot-impressed conductor tracks 28, 30, the conductor tracks can also be produced by first applying a metallization to the entire surface of the injection-molded part and then machining the conductor tracks 28 and 30 out of this metallization by laser ablation. It is fundamentally sufficient to expose one of the two conductor tracks 28 or 30; the second conductor track is then formed by the remaining metallization. Once again, polyamide or LCP (Liquid Crystal Polymer) materials can be used as the material for the injection-molded part 12. It is also possible to solder the ends of the connection cable 24 directly to the contact lugs 31 of the conductor tracks 28 and 30, or to join connection pins of a plug or of a crimped device 14 to the contact lugs 31 by press-fitting in holes in the plastic basic body 12.

On the opposed, sensing end 26 of the basic component 10, an integrated circuit 32 is joined, on its inside not visible in the drawing, by gold terminal humps 37 to the terminal points 34 and 36 of the conductor tracks 28 and 30. The conductor tracks 28 and 30 are furthermore bridged, between the connection of the integrated circuit 32 and the crimped device 14, by a capacitor 38, which keeps high-frequency interference that might penetrate via the connection cable 24 away from the integrated circuit 32. The integrated circuit is equipped in a known manner with at least one Hall element, which reacts to the magnetic field of the permanent magnet 16, which can vary as a result of external ferromagnetic parts, with a variable Hall voltage. In the preferred used of the motion sensor of the invention as an rpm sensor for the wheel rotation of a motor vehicle, the sensing end 26 of the motion sensor is adjacent to a ferromagnetic part, embodied as a ring gear 47, that rotates with the wheel of the motor vehicle; the magnetic field of the permanent magnet 16 that varies as a result of the alternation of teeth and toothed gaps, determines the output voltage of the motion sensor. The permanent magnet 16 here is part of the measured value transducer device. However, it can also be excited by means of an external magnetic pulse wheel or the like and then the permanent magnet is dispensed with as part of the measured value transducer device.

The electrical contacting of the integrated circuit 32 to the terminal points 34, 36 of the conductor tracks 28, 30 and its fastening to the face end of the basic component 10 are done by the flip-chip technique, in which gold terminal humps 37 of the integrated circuit component 32 are bonded to the terminal points 34 and 36 in wireless fashion. This bonding can be done either directly or with the insertion of an isotropically electrically conductive adhesive. The active side of the integrated circuit, in the flip-chip contacting, points toward the terminal points 34, 36 and is additionally mechanically joined to the face end of the basic component 10 by means of low-viscosity, heat-hardenable plastic, a so-called underfiller.

FIG. 5 shows the completely assembled basic component 10, in which the integrated circuit 32 and the sensing end 26, receiving the permanent magnet 16, of the basic component 10 are sheathed by a prefabricated, cup-shaped, thin-walled polyamide plastic covering 40.

FIGS. 6 and 7, finally, show the completion of the motion sensor by means of an external injected encapsulation 42 of polyamide, which covers both the edge 41 on the open end of the cup-shaped plastic covering 40 and the end of the connection cable 24. In FIG. 6, only the contours of the concluding encapsulation are shown, while in FIG. 7 the final shape of the motion sensor with the external encapsulation 42 is visible, additionally having a connection tab 44 with a fastening bush 46 for installing the sensor.

With the motion sensor of the invention and the method for producing such a sensor, in particular an rpm sensor for the wheel rotation of a motor vehicle, a compact, sturdy, permanently protected arrangement is obtained, which meets the stringent demands made of sensors in terms of quality and requires only very little installation space, so that it can be installed without difficulty, for instance in the region of the wheel bearing of a motor vehicle wheel. The Hall element used as the measuring element is part of the integrated circuit 32 and is also accommodated, equally well protected, in the cup-shaped plastic covering 40.

The permanent magnet 16 used to generate the variable magnetic field can be located, with only a slight air gap width, in the immediate vicinity of a ferromagnetic transducer part, embodied for instance as a ring gear 47. The Hall element or elements in the integrated circuit 32 react to the changes in magnetic field that occur and convert them into electrical signals, which via the connection cable 24 reach connected control units. Instead of a pulse wheel, it is understood that a linear element may also be used as the transducer part, and instead of Hall elements, magnetoresistive elements can for instance be used. The measurement signals can serve to determine the speed, the acceleration, the acceleration gradient, and/or a rotation angle. The form of the external encapsulation 42 of the sensor is as a rule determined by where it will be installed.

1. A motion sensor, in particular an rpm sensor for the wheel rotation of a motor vehicle, which has an integrated circuit, connectable preferably via an electrical cable, with a measured value transducer array and an electronic circuit arrangement for processing the measurement signals, characterized in that a housingless integrated circuit (32) of the flip-chip type is mounted on a basic component (10) provided with conductor tracks (28, 30) and embodied as an MID (Molded Interconnect Device) component and is enclosed jointly with the conductor tracks (28, 30) and optionally further elements (16, 38) by a diamagnetic or paramagnetic covering (40, 42).

2. The motion sensor in accordance with claim 1, characterized in that the basic component (10) is embodied as an injection-molded part metallized on the surface.

3. The motion sensor in accordance with claim 1, characterized in that a plastic basic body (12) of the basic component (10) is produced from at least two different plastic components, at least one of which is metallizable on its surface for forming at least one conductor track (28, 30).

4. The motion sensor in accordance with claim 3, characterized in that the plastic components are LCP (Liquid Crystal Polymer) plastics.

5. The motion sensor in accordance with claim 1, characterized in that at least one conductor track (28, 30) is machined out of a metallization of the basic component (10) by means of laser ablation.

6. The motion sensor in accordance with claim 1, characterized in that the basic component (10) has hot-stamped conductor tracks (28, 30).

7. The motion sensor in accordance with claim 1, characterized in that a permanent magnet (16) is inserted into the basic component (10).

8. The motion sensor in accordance with claim 1, characterized in that the integrated circuit (32) is sheathed, together with a permanent magnet (16), by a cup-shaped diamagnetic or paramagnetic covering, preferably a plastic covering (40).

9. The motion sensor in accordance with claim 1, characterized in that the integrated circuit (32) has gold terminal humps (37) and is secured and contacted with them to terminal points (34, 36) of the conductor tracks (28, 30).

10. The motion sensor in accordance with claim 9, characterized in that the terminal humps (37) of the integrated circuit (32) are joined to the terminal points (34, 36) of the conductor tracks (28, 30) on the basic body (10) directly or by means of an isotropically electrically conductive adhesive.

11. The motion sensor in accordance with claim 1, characterized in that the integrated circuit (32) is joined mechanically to the basic component (10) by a plastic underfiller.

12. The motion sensor in accordance with claim 1, characterized in that a connection device (14) is integrated into a plastic basic body (12) of the basic component (10) that is produced by casting or injection molding of thermoplastic.

13. The motion sensor in accordance with claim 1, characterized in that in the region between the integrated circuit (32) and the contact lugs (31) for the external connection, the conductor tracks (28, 30) are bridged by a capacitor (38).

14. The motion sensor in accordance with claim 1, characterized in that the integrated circuit (32) and the part of the basic component (10) receiving the permanent magnet (16) are surrounded by a prefabricated, cup-shaped, diamagnetic or paramagnetic covering (40), preferably by a plastic covering, which at least with its opening edge (41) reaches into an outer encapsulation (42) of the sensor, which joins the cup-shaped covering (40) to the basic component (10), forming a unit.

15. A method for producing a motion sensor, in particular an rpm sensor for the wheel rotation of a motor vehicle, which has an integrated circuit, connectable preferably via an electrical cable, with a measured value transducer array and an electronic circuit arrangement for processing the measurement signals, characterized in that by casting or injection molding of thermoplastic, a basic component (10, 12) is produced; that conductor tracks (28, 30) for the connection to a housingless integrated circuit (32) are mounted on the basic component (10, 12); that the integrated circuit (32) is joined in wireless fashion by the flip-chip technique to the conductor tracks (28, 30; 34, 36), and the arrangement is then sheathed at least partly with an outer encapsulation (42) in a further casting or injection molding process.

16. The method in accordance with claim 15, characterized in that the plastic basic body (12) of the basic component (10) is injection-molded in at least two work steps from at least two different thermoplastic components, of which at least one is metallizable in currentless fashion and at least a further one is not metallizable.

17. The method in accordance with claim 16, characterized in that first, an injection-molded part (11) is produced from a metallizable plastic component, which is then spray-coated with a non-metallizable plastic component, forming the plastic basic body.

18. The method in accordance with claim 16, characterized in that the conductor tracks (28, 30) are mounted on the plastic basic body (12) by currentless metallization of the metallizable plastic component.

19. The method in accordance with claim 15, characterized in that a permanent magnet (16) is spray-coated with a non-metallizable plastic in the process of injection molding of the plastic basic body (12).
